(19) United States
(12) Patent Application Publication
(10) Pub. No.: US 2019/0136607 A1
(43) Pub. Date: May 9, 2019

(54) REINFORCED FOLDING DOOR AND HINGE ASSEMBLY

(71) Applicant: Woodfold Mfg., Inc., Forest Grove, OR (US)

(72) Inventors: Mark F. Lewis, Portland, OR (US); Rick Scott Alvarado, Gaston, OR (US)

(73) Assignee: Woodfold Mfg., Inc., Forest Grove, OR (US)

(21) Appl. No.: 16/240,996

(22) Filed: Jan. 7, 2019

Related U.S. Application Data
(63) Continuation of application No. 15/881,597, filed on Jan. 26, 2018.
Application No. 15/881,597 is a continuation of application No. 15/171,478, filed on Jun. 2, 2016, now Pat. No. 9,879,471.
(60) Provisional application No. 62/235,455, filed on Sep. 30, 2015.

(51) Int. Cl. E06B 3/48; E05D 7/00; E05D 3/02; E05D 15/26; E05D 7/12; E05D 11/06

(52) U.S. Cl. CPC E06B 3/481; E05D 7/009; E05D 3/02; E05D 15/26; E05D 15/0656; E05D 11/06; E05Y 2900/142; E05Y 2900/132; E05D 7/12

(57) ABSTRACT

An accordion type folding door system having a plurality of elongated panels hinged together along their longitudinal side edges into a pleated or zig zag arrangement, the folding panels being interconnected by a hinge assembly. The hinge assembly is disposed between and interconnects a pair of adjacent panels, each of the pair of interconnected adjacent panels including a side edge having longitudinal groove and an extension flange, wherein the hinge assembly includes a hinge pin and a plurality of hinge knuckles disposed vertically end-to-end in alternating arrangement on the hinge pin, the hinge knuckle having a tubular central opening for accepting the hinge pin, an outwardly extending tongue for connecting to a corresponding longitudinal groove in an adjacent panel in a tongue and groove connection, and an outwardly flared wedge that extends beyond the extension flanges of the panels, whereby the wedge cooperates with the extension flanges to limit angular folding extension to a maximum desired angle.

### RELATED APPLICATION DATA

This application is a continuation of application Ser. No. 15/881,597 filed Jan. 26, 2018, which is a continuation of Ser. No. 15/171,478 filed Jun. 2, 2016, now Pat. No. 9,879,471, which claims priority under 35 U.S.C. § 119(e) to U.S. Provisional Application No. 62/235,455 filed on Sep. 30, 2015, these applications are hereby incorporated by reference.

### BACKGROUND

The field of the present invention is directed to folding doors such as used for closets, elevators and room entrances.

An accordion type folding door comprises an assembly of vertically arranged panels placed side-by-side and suspended from a suitable track. The adjacent side edges of the panels are interconnected by sheet vinyl plastic hinges.

Alternately, the vinyl plastic hinges may be replaced as described in U.S. Pat. No. 4,922,987 with hinging assemblies that interconnect the panels, the hinging assemblies comprising a plurality of knuckles made of hard durable material (plastic or metal) and tongue and groove means for attachment of the knuckles to the side margins of the adjacent panels in an alternating arrangement, i.e., with alternate knuckles attached to the same panel, with a hinge pin made of steel or other stout material received in the knuckles. Though this design with the interconnection exhibits higher strength over the prior vinyl plastic hinge, the present inventor(s) have recognized potential for additional improvement.

### BRIEF DESCRIPTION OF THE DRAWINGS

FIG. 1 is an isometric view of a top portion of a folding door assembly in an extended or closed position.

FIG. 2 is a cross-sectional view of the folding door assembly of FIG. 1 taken along line 2-2.

FIG. 3 is a partial cross-sectional view of a portion of the folding door assembly of FIG. 1 taken along line 3-3, on an enlarged scale.

FIG. 4 is a partial cross-sectional view, similar to FIG. 3, but with the door in a folded or open position.

FIG. 5 is a perspective view of a hinge knuckle unit of the folding door assembly of FIG. 1.

FIG. 6 is a top end plan view of the hinge knuckle unit of FIG. 5 showing example dimensions.

FIG. 7 is an isometric view of the bottom connection of the folding door assembly of FIG. 1.

FIG. 8 is an isometric view of the retainer screw shown in FIG. 7.

FIG. 9 is a full length isometric view of a four panel folding door assembly.

FIG. 10 is a top diagrammatic view of the four panel folding door assembly of FIG. 9 in the closed, un-folded, extended position.

FIG. 10A is a top diagrammatic view of the four panel folding door assembly of FIG. 10 in the open, folded, contracted position

FIG. 11 is a front side perspective view of the slide plate section of the folding door assembly of FIG. 9, on an enlarged scale.

FIG. 12 is a left side perspective view of the slide plate section of FIG. 11.

FIG. 13 is a front side perspective view of the slide post section of the folding door assembly of FIG. 9, on an enlarged scale.

FIG. 14 is a partial cross-sectional view of a portion of the folding door assembly of FIG. 1, on an enlarged scale, with an alternate hinge knuckle unit.

FIG. 15 is a top end plan view of the hinge knuckle unit of FIG. 14.

FIG. 16 is a top diagrammatic view of an eight panel folding door assembly.

FIG. 17 is a top diagrammatic view of a nine panel folding door assembly.

FIG. 18 is a diagrammatic view of a hinge knuckle arrangement for a folding door assembly according to an embodiment.

Additional aspects and advantages will be apparent from the following detailed description of preferred embodiments, which proceeds with reference to the accompanying drawings.

### DETAILED DESCRIPTION OF PREFERRED EMBODIMENTS

Certain embodiments will now be described with reference to the drawings. To facilitate description, any element numeral representing an element in one figure will represent the same element in any other figure. Certain embodiments will describe a particular folding door, but it will be appreciated that details of the system may be applied in other forms such as folding wall sections or the like.

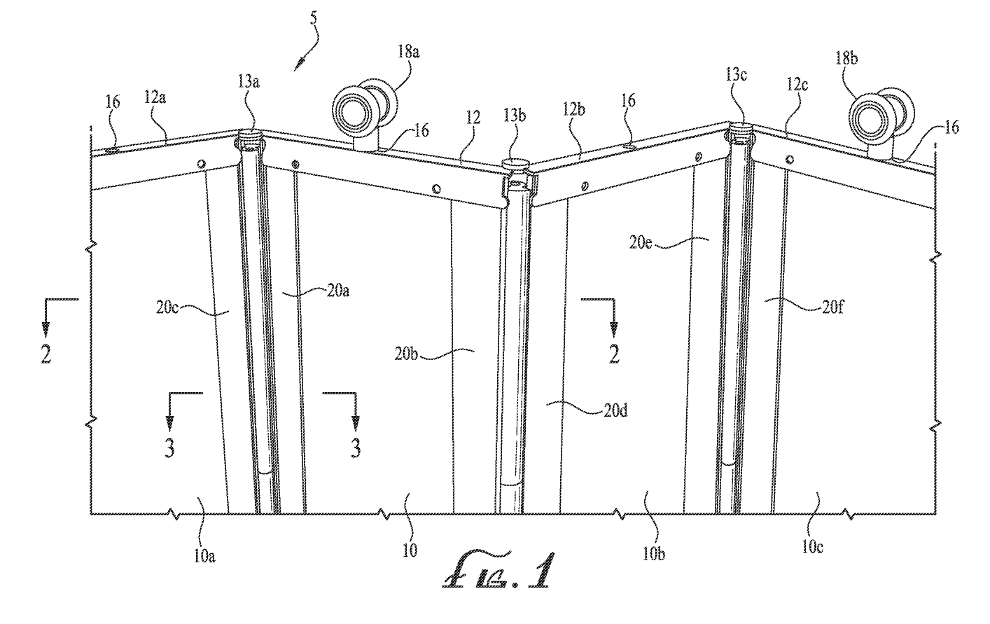

FIGS. 1-3 illustrate an accordion type folding door system 5 according to a first embodiment. Certain features of the folding door system 5 are similar to those described in U.S. Pat. No. 4,922,987 hereby incorporated by reference. The folding door system 5 comprises a plurality of elongated panels 10 hinged together along their longitudinal side edges into the illustrated pleated or zig zag arrangement. Four panels 10, 10a, 10b, 10c are illustrated in FIG. 1, but there may be any suitable plurality of panels, two or more. The panels 10, 10a, 10b, 10c may comprise any suitable structural material, such as wood, particle board, clear or opaque plastic, or metal.

Panels 10, 10a, 10b, 10c are suitably framed, in part by cap pieces 12, 12a, 12b, 12c mounted on the top and bottom edges of each panel. The cap pieces 12, 12a, 12b, 12c may be channel-shaped (in cross-section) and receive the top and bottom margins of the respective panels 10, 10a, 10b, 10c In the first embodiment, the cap pieces 12, 12a, 12b, 12c are hinged together, hinges 13a, 13b, 13c connecting an adjacent pair of cap pieces. For example, the hinge 13a connects the cap piece 12a to the cap piece 12, the hinge 13b connects the cap piece 12 to the cap piece 12b, and the hinge 13c connects the cap piece 12b to the cap piece 12c. The hinges 13a, 13b, 13c are capped at the bottom and do not extend into the central hinge mechanisms described below. Such a construction may help prevent binding of adjacent cap pieces when folding.

The central segments of cap pieces 12, 12a, 12b, 12c are provided with openings 16. These openings provide means for mounting roller assemblies 18a, 18b, on selected panels (in the panel 10 and the panel 10c), by which the folding door system 5 is suspended on a ceiling track, not illustrated but of conventional construction. The ceiling track is mounted across the entrance of the space to be closed off by the folding door system 5.

The panels 10, 10a, 10b, 10c each includes longitudinal side framing members along panel side edges. Specifically, the panel 10 includes longitudinal side framing members 20a, 20b; the panel 10a includes longitudinal side framing member 20c (the other side framing member not shown); the panel 10b includes longitudinal side framing members 20d, 20e; and the panel 10c includes longitudinal side framing member 20f (the other side framing member not shown).

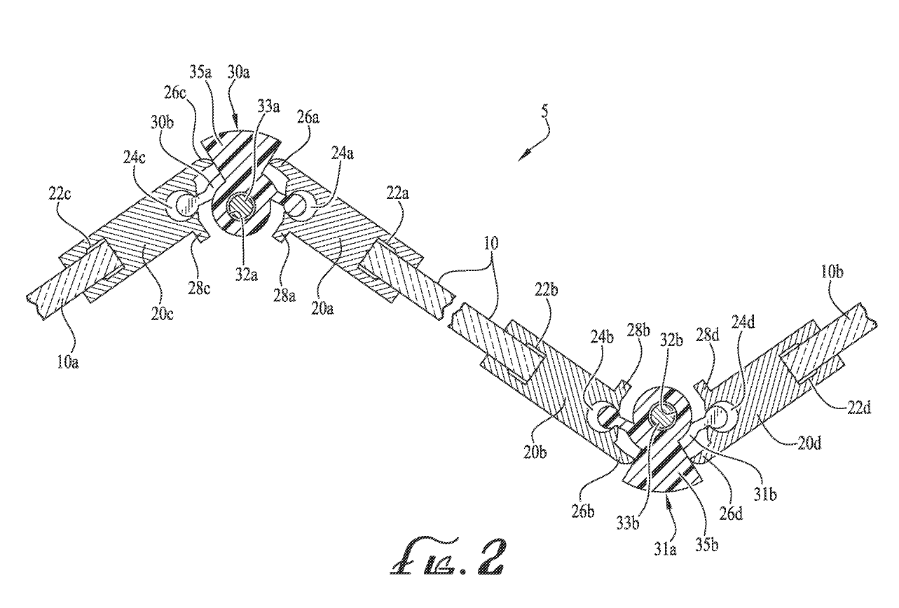

FIG. 2 is a cross section of FIG. 1 illustrating a portion of the hinge connections, three of the panels 10, 10a, 10b showing example construction. Each side framing member 20a-d may comprise a metal strip having the cross section as illustrated in FIG. 2. Each side framing member is shaped with an inner side margin provided with a respective longitudinal recess or groove 22a-d. The outer side margin of each panel 10, 10a or 10b may be dimensioned to fit into respective groove 22a-d, along with a quantity of adhesive for securing the panel into the groove.

Each side framing member 20a-d is also provided along its outer margin with a respective longitudinally extending groove 24a, 24b, 24c, 24d. Each of the side framing members 20a-d is also provided, along its sides, with a respective pair of longitudinally extending flanges. Framing member 20a has extending flanges 26a, 28a, framing member 20b has extending flanges 26b, 28b, framing member 20c has extending flanges 26c, 28c, and framing member 20d has extending flanges 26d, 28d. These flanges serve to shield the mechanism of the central hinge system by means of which two adjacent panels are coupled together in hinging relation.

Top hinges 13a, 13b, 13c provide the structural support for the door structure, by means of which the panels are hinged to each other in the desired configuration. A second hinging connection is provided by the central hinge system that may extend about the full length of the panels, from top to bottom.

In addition to providing a hinging function, the central hinging system may serve a barrier function, sealing off the space between adjacent panels in such a manner as to prevent access to the area behind the door. The central hinging system between adjacent framing members 20a, 20c of panels 10, 10a includes a plurality of hinge knuckles 30a, 30b, etc. and the central hinging system between adjacent framing members of panels 10, 10b includes a plurality of hinge knuckles 31a, 31b, etc. The hinge knuckle 30a includes an outwardly flared wedge section 35a and the hinge knuckle 30b disposed below the hinge knuckle 30a also includes an outwardly flared wedge section (not visible). A similar plurality of hinge knuckles 31a, 31b are shown in FIG. 2 between adjacent framing members 20b, 20d of panels 10, 10b. The hinge knuckle 31a includes an outwardly flared wedge section 35b and the hinge knuckle 31b disposed below the hinge knuckle 31b also includes an outwardly flared wedge section (not visible) Further details of the central hinging systems will now be described with respect to just one of the connections with reference to FIGS. 3-7 and 18 but the description equally applies to the other connections and panels in the folding door system 5.

As shown particularly in FIGS. 2-5, the central hinge assembly comprises a plurality of hinge knuckles 30a, 30b disposed end to end between each pair of adjacent framing members 20a, 20c, and a hinge pin 33a received within the central tubular openings of the knuckles (an opening 32a in hinge knuckle 30a is shown). Similarly as shown in FIG. 2, another central hinge assembly comprises a plurality of hinge knuckles 31a, 31b disposed end to end between a pair of adjacent framing members 20b, 20d, and a hinge pin 33b received within the central tubular openings of the knuckles (an opening 32b in hinge knuckle 31a is shown).

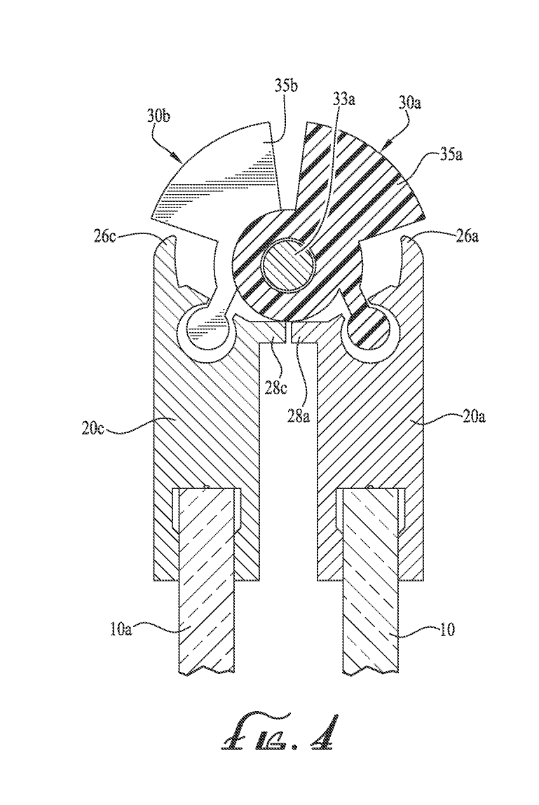

FIG. 5 illustrates an example hinge knuckle 30a. The hinge knuckle 30a may be made of PVC plastic having desired properties of strength, rigidity, and temperature insensitivity. The element may be formed out of other suitable plastics, metals, or combinations. The PVC plastic may be formed in a desired color to match the panels sections for enhancing aesthetics. The hinge knuckle 30a is provided with a cylindrical central section 37a forming a central opening 32a and a longitudinally extending tongue 34a terminating in a bead 36a that nests within the longitudinally extending groove 24a. The hinge knuckle 30a also has an outwardly flared wedge section 35a that extends beyond the flanges 26a, 26c.

The tongue 34a of the hinge knuckle 30a with the associated bead 36a cooperates with the longitudinally extending groove 24a on the framing member 20a and a tongue 34b of the hinge knuckle 30b with an associated bead 36b cooperates with the longitudinal extending groove 24c, thereby collectively forming tongue and groove connections by means of which the hinge knuckles 30a, 30b, etc. are coupled to framing members 20a, 20c, in alternating positions/orientations. In other words, direction and connection of the beads will be arranged in an alternating fashion with one hinge knuckle connecting to a panel on one side and the next/adjacent hinge knuckle (above and below) connecting to the panel on the other side, thus forming the central hinge assembly of the hinge system. The beads 36a, 36b may be round rod shape (as illustrated) seating within the respective longitudinally extending grooves 24a, 24c that may be round, cylindrical shape, or the beads 36a, 36b may be other suitable shape such as T-shaped, disposed in a suitably-shaped groove.

Though any number of hinge knuckle units, two or more, may serve the central hinge assembly function, multiple hinge knuckle units may provide advantages of strength and visibility blockage. As an example, for a typical height door of 78 ⅛ inches, seven full length (e.g., 10 inch long) hinge knuckles (arranged in alternating directions) may be stacked with a first partial length (e.g., 4 inch long) hinge knuckle on the top and a second partial length (4 inch long) hinge knuckle (e.g. hinge knuckle 30x) on the bottom. FIG. 18 illustrates an example hinge knuckle assembly 100 arrangement with eight full length (10 inch long) hinge knuckles 30a, 30b, 30c, 30d, 30e, 30f, 30g, 30h) arranged in alternating directions stacked with a first partial length (4 inch long) hinge knuckle 30x on the bottom and a second partial length (4 inch long) hinge knuckle 30y on the top, aligned and secured together by pin/post 33a. Other sizes (and numbers) of hinge knuckle units may be employed.

As previously mentioned, the hinge knuckle 30a may include an outwardly flared wedge section 35a that extends beyond the flanges 26a, 26c. The wedge section 35a cooperates with the flanges 26a, 26c limiting the minimum size of gap G1 and limiting the maximum angle B1 (see FIG. 3) that the folding door sections may extend to an angle B1 of about 110°. By limiting the angular un-folding extension to a desired maximum angle, and providing limiting resistance along the entire length of the door via operation of the wedge sections, the strength of the folding door assembly to resist horizontal pressure is enhanced. The wedge section 35a (of the hinge knuckle 30a) may be flared or pie-shaped as illustrated, or may alternately be square, rectangular, with curved sides or other suitable shape.

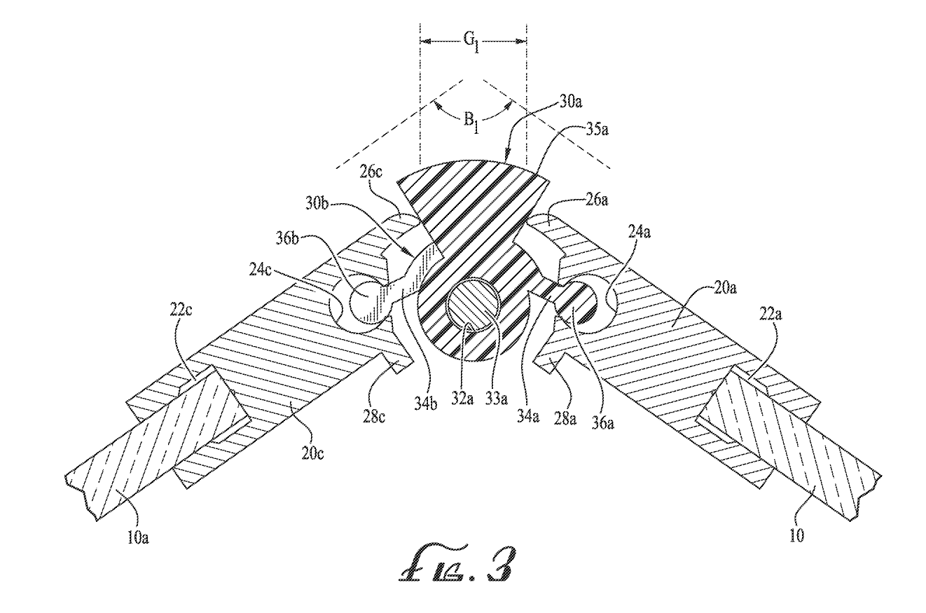

While FIG. 3 illustrates folding door sections in a maximum closed or un-folded position, FIG. 4 illustrates the door panels 10, 10a of folding door sections in the maximum open position, the door panels in a folded, parallel position next the wall.

FIG. 6 illustrates the hinge knuckle 30a of FIGS. 3-5 and further provides an example size dimensions: radius R1 (of the central openings 32a)=0.065 inches; radius R2 (of the cylindrical central section 37a)=0.133 inches; radius R3=0.176 inches; radius R4=0.343 inches; radius R5=0.050 inches; length D1=0.210 inches; length D2=0.165 inches; angle A1 (of the wedge section 35a)=63.5°; and angle A2 (from the wedge section 35a to the bead 36a)=57.5°.

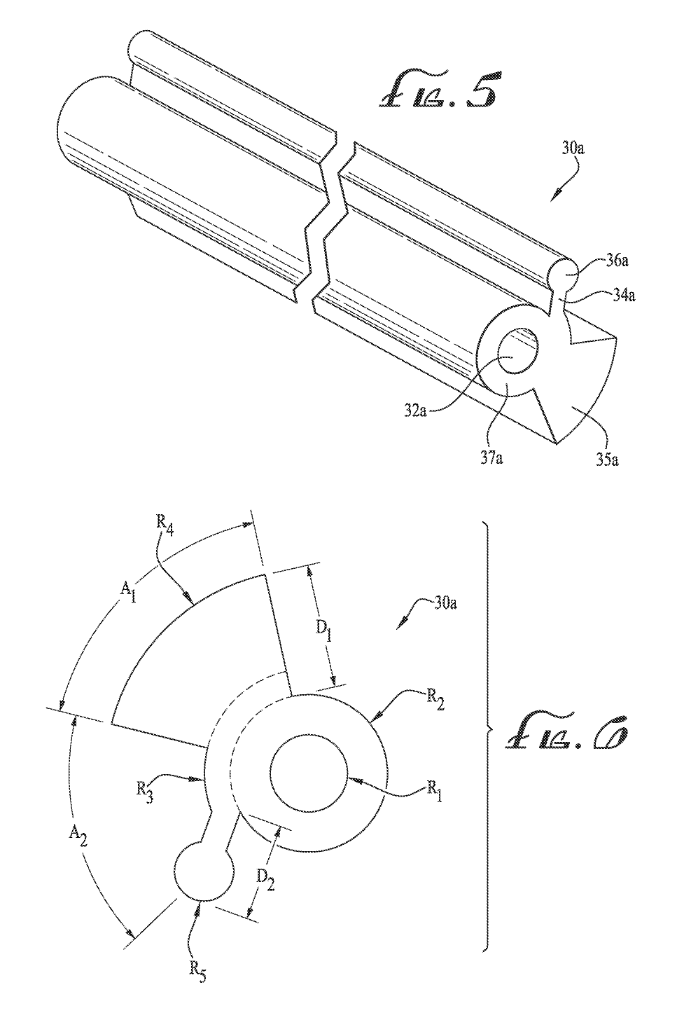

FIGS. 7-8 illustrate an example bottom connection of the folding door assembly of FIG. 1 according to an embodiment. The door panels have bottom cap pieces 42a, 42b (similar to the top cap pieces 12, 12a, 12b) that are hinged together via hinge 40 connecting the bottom cap pieces of an adjacent pair of panels. The hinge 40 is capped and does not extend into the central hinge mechanism. The hinge pin 33a “floats” in an installed relation through the central openings 32a in the hinge knuckles and thus is not secured directly to a structural member. A screw 50 (only the head of the screw is visible in FIG. 7, and further details of the screw 50 are shown in FIG. 8) is secured into the central opening of the bottom-most hinge knuckle 30x thus trapping the hinge pin 33a in place in operative position. In the event the screw 50 becomes dislodged from the knuckle unit 30x, the screw 50 is provided with a sufficient length shaft that the screw would slide down with its head into contact with the hinge 40 wherein a portion of the screw shaft still extending into the central opening of the hinge knuckle 30x and thus continue to retain the hinge pin 33a in place.

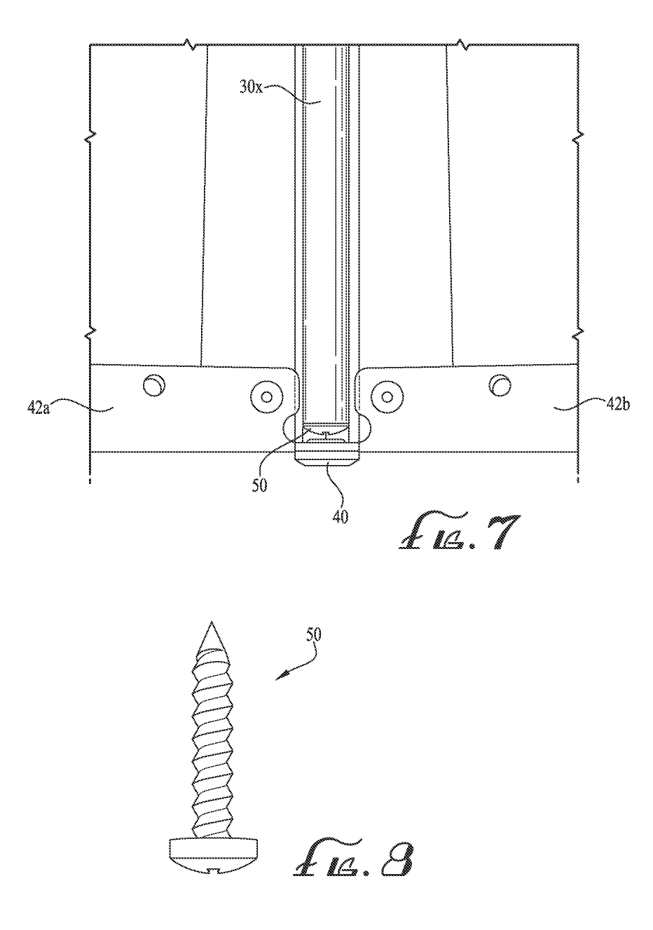

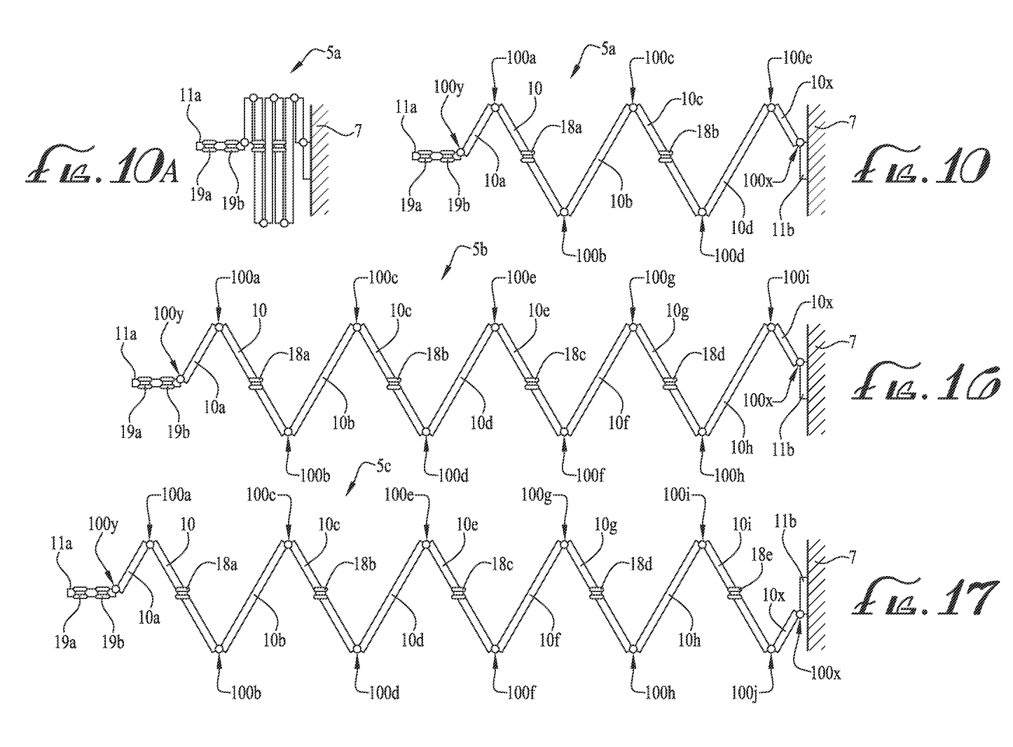

FIGS. 9-13 illustrate details and operation of a four panel door assembly 5a. The same elements in these figures are shown by common numerals from the previously described figures. The door assembly 5a includes four full size door panels 10, 10b, 10c, 10d, two half door panels 10a, 10x, a slide panel section 11a and a wall panel section 11b secured to the wall 7. The slide panel section 11a is supported and guided at the top on the ceiling track by mounting roller assemblies 19a, 19b, and at the bottom by slide tab 60 that is disposed in and slides along floor channel 110. Alternating panel sections also include a top mounting roller assembly (the panel section 10 includes a mounting roller assembly 18a and the panel section 10c includes mounting roller assembly 18b) and alternating panel sections also include a bottom slide post that engages the floor channel 110 (the panel section 10 includes slide post 70a and the panel section 10c includes slide post 70b). The panel sections are interconnected by hinge systems, as previously described, both at the top cap pieces (hinges 13a-e, 13x, 13y), at the bottom rails, and by central hinge assemblies (100a-e, 100x, 100y (each central hinge assembly comprising a central hinge pin and a plurality of stacked hinge knuckles such as assembly 100 of FIG. 18). Specifically, slide panel 11a is connected to half panel 10a by hinge knuckle assembly 100y, half panel 10a is connected to panel 10 by hinge knuckle assembly 100a, panel 10 is connected to panel 10b by hinge knuckle assembly 100b, panel 10b is connected to panel 10c by hinge knuckle assembly 100c, panel 10c is connected to panel 10d by hinge knuckle assembly 100d, panel 10d is connected to half panel 10x by hinge knuckle assembly 100e, and half panel 10x is connected to wall panel 11b by hinge knuckle assembly 100x.

Both elements of the central hinge assembly (the hinge knuckle and the hinge pin) are fabricated from hard, durable, strong material so that they resist forcible entry through the central hinge structure. Thus hinge pin 33a may be made of a suitable metal such as steel. The hinge knuckles 30a, 30b etc. may be fabricated from a strong, hard, plastic such as rigid vinyl (PVC) plastic or other suitable material such as metal (e.g., brass).

Thus, when the door is in its extended (un-folded) position of FIGS. 1, 2, 9 and 10, the joints on one side are protected by means of flanges 26a, 26c engaging the wedge 35a. On the other side of the door, the space between the panels is protected by the continuous barrier presented by hinge knuckles 30a, 30b, etc. mounted on (e.g., made of steel) hinge pin 33a. The door accordingly is protected against vandalism and entry by the application of force other than a force of door-destructive caliber.

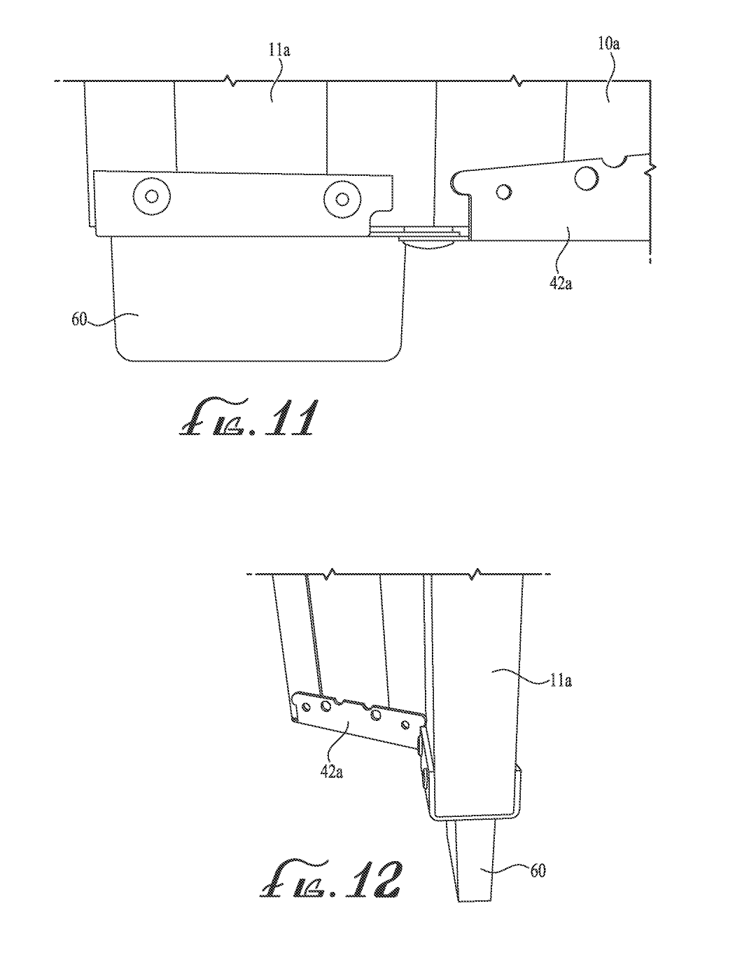

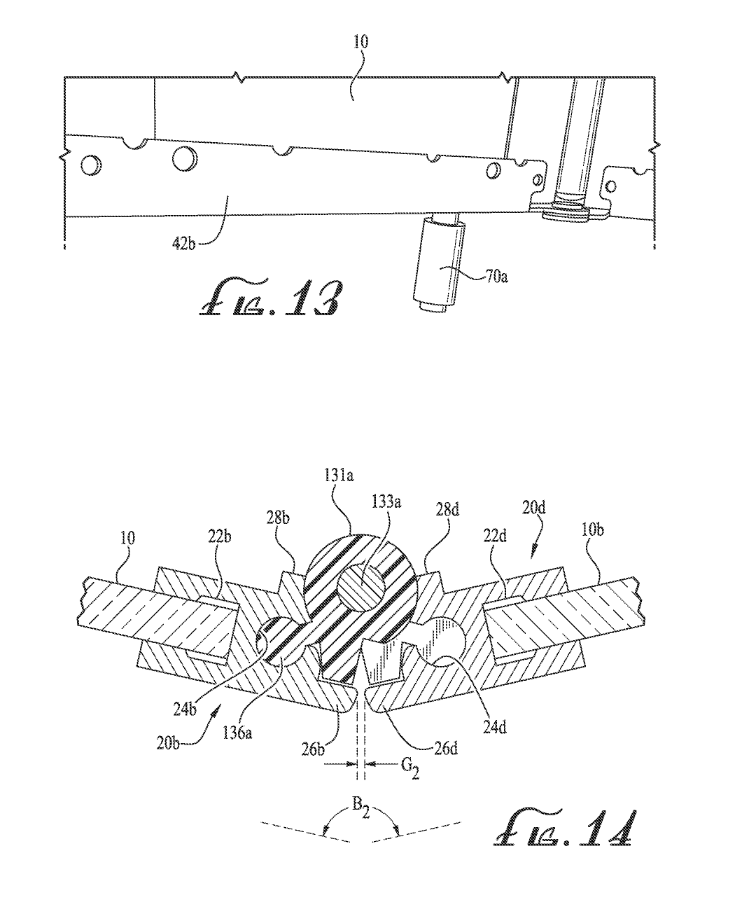

FIGS. 14-15 illustrate an alternate hinge knuckle 131a as described in U.S. Pat. No. 4,922,987. The alternate hinge knuckle 131a includes a cylindrical central section 137a forming a central opening 132a and a longitudinally extending tongue 134a terminating in a bead 136a that nests within the longitudinal extending groove 24b. Multiple hinge knuckles are stacked to a desired (as previously described) and secured by central pin 133a. The alternate hinge knuckle 131a does not include the outwardly extending wedge 35a of the hinge knuckle 30a of FIG. 5 and thus permits the adjacent door panels 10a, 10b to open to a larger angle B2 as shown in FIG. 14, and a smaller gap G2 between adjacent extending flanges 26b, 26d (the extending flanges 26b, 26d contacting each other to limit opening of the panels).

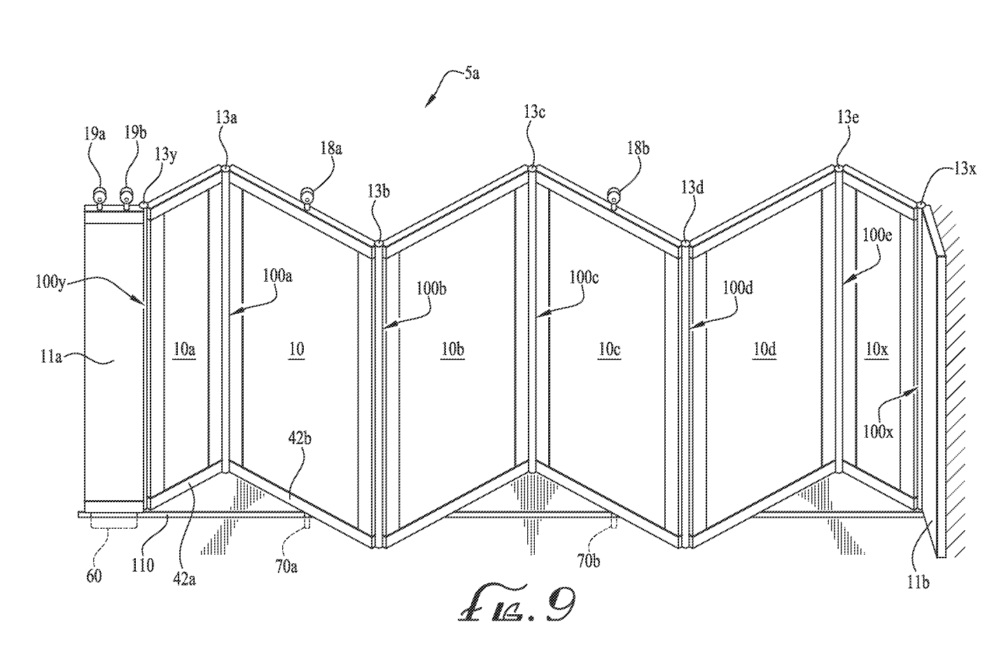

Each of the hinge knuckle assembles 100a-e, 100x, 100y may comprise the new design of the hinge knuckle 30a of FIG. 5, but a door assembly may comprise a combination of the hinge knuckle assemblies of different designs. The new hinge knuckle design 30a of FIG. 5 with the wedge 35a provides for stronger force resistance but permits a smaller extension angle B1 (see FIG. 3) than the extension angle B2 permitted by the old hinge knuckle design 131a (see FIG. 14). It has been determined that only smaller number of hinge assemblies are needed to be constructed with the new hinge knuckle design to achieve superior resistance performance, and thus most of the hinge assemblies may be constructed with the old hinge knuckle design to permit larger extension angles. For example, the door assembly 5a of FIG. 10 may be configured as set forth in the following Table A with the new hinge knuckle configuration arranged only on the inside hinge sections:

TABLE A
Four Panel Door Assembly 5a

| Hinge | Hinge Knuckle |
|---|---|
| Assembly | Configuration |
| 100y | old |
| 100a | new |
| 100b | old |
| 100c | new |
| 100d | old |
| 100e | new |
| 100x | old |

Alternately, for a door assembly 5a as in FIG. 10, the new hinge knuckle configuration may be disposed only on outside hinge sections as set forth in Table B:

TABLE B
Four Panel Door Assembly 5a (alternate)

| Hinge | Hinge Knuckle |
|---|---|
| Assembly | Configuration |
| 100y | old |
| 100a | old |
| 100b | new |
| 100c | old |
| 100d | new |
| 100e | old |
| 100x | old |

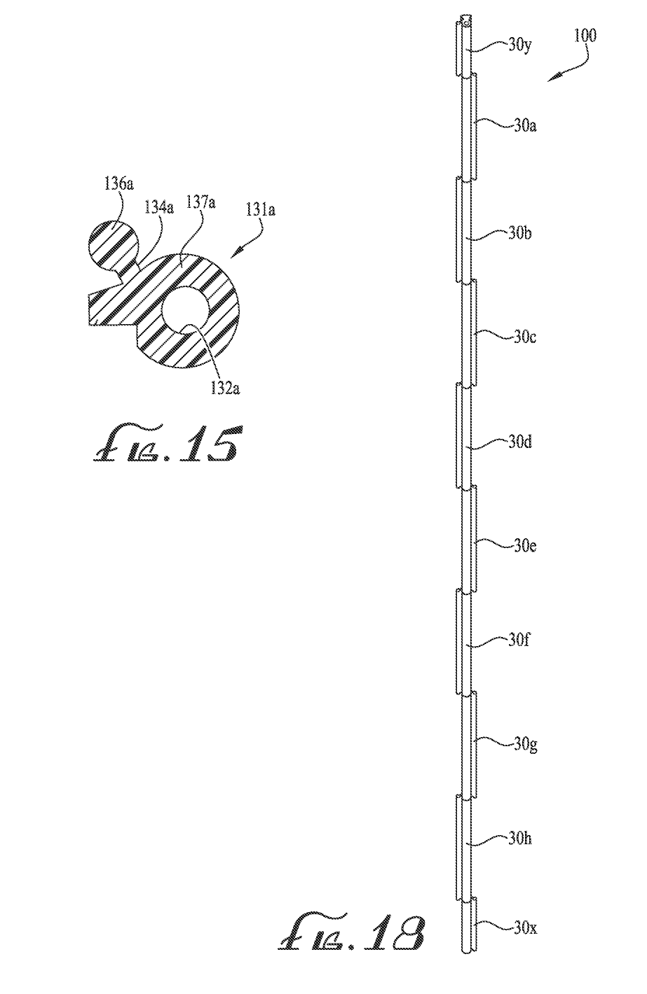

FIGS. 16 and 17 illustrate larger size panel door assemblies. The eight panel door assembly 5b in FIG. 16 includes eight full size panels 10, 10b, 10c, 10d, 10e, 10f, 10g, 10h, half panel 10a, half panel 10x, slide panel 11a, and wall panel 11b. The panel sections are pivotally connected by hinge assemblies 100a-i, 100x, 100y. Alternating panel sections include a top mounting roller assembly (the panel section 10 includes a mounting roller assembly 18a, the panel section 10c includes mounting roller assembly 18b, the panel section 10e includes a mounting roller assembly 18c, the panel section 10g includes mounting roller assembly 18d) and each alternating panel sections (10, 10c, 10e, 10g) also includes a bottom slide post (such as slide post 70a in FIG. 13) that engages the floor channel 110.

The door assembly 5b of FIG. 16 may be configured entirely with the new style hinge knuckle 30a, but may alternately be configured with the new hinge knuckle configuration arranged on most of the inside ones of hinge assemblies, as set forth in the following Table C, or only on the outside (100b, 100d, 100f, 100h):

TABLE C
Eight Panel Door Assembly 5b

| Hinge | Hinge Knuckle |
|---|---|
| Assembly | Configuration |
| 100y | old |
| 100a | old |
| 100b | old |
| 100c | new |
| 100d | old |
| 100e | new |
| 100f | old |
| 100g | new |
| 100h | old |
| 100i | old |
| 100x | old |

The nine panel door assembly 5c in FIG. 17 includes nine full size panels 10, 10b, 10c, 10d, 10e, 10f, 10g, 10h, 10i, half panel 10a, half panel 10x, slide panel 11a, and wall panel 11b. The panel sections are pivotally connected by hinge assemblies 100a-j, 100x, 100y. Alternating panel sections include a top mounting roller assembly (the panel section 10 includes a mounting roller assembly 18a, the panel section 10c includes mounting roller assembly 18b, the panel section 10e includes a mounting roller assembly 18c, the panel section 10g includes mounting roller assembly 18d, the panel section 10i includes mounting roller assembly 18e) and each alternating panel sections (10, 10c, 10e, 10g, 10i) also includes a bottom slide post that engages the floor channel 110.

The door assembly 5c of FIG. 17 may be configured with the new style hinge knuckle 30a, but may also include may be configured with the new hinge knuckle configuration arranged only on most of the inside hinge sections 100c, 100e, 100g as set forth in the following Table D:

TABLE D
Nine Panel Door Assembly 5c

| Hinge | Hinge Knuckle |
|---|---|
| Assembly | Configuration |
| 100y | old |
| 100a | old |
| 100b | old |
| 100c | new |
| 100d | old |
| 100e | new |
| 100f | old |
| 100g | new |
| 100h | old |
| 100i | old |
| 100j | old |
| 100x | old |

Other combinations of old and new style hinge knuckles may be employed to provide a desired strength property (provided by the new design) or larger extension angle (provided by the old design).

Though the present invention has been set forth in the form of its preferred embodiments, it is nevertheless intended that modifications to the disclosed systems and methods may be made without departing from inventive concepts set forth herein.

1. A folding door system, comprising:
a pair of panels arranged side-by-side; and
a hinge assembly disposed between a pair of panels, each of the pair of panels including a side edge having a longitudinal groove and an extension flange,
wherein the hinge assembly comprises:
a plurality of hinge knuckles disposed vertically end-to-end, at least one of the hinge knuckles comprising a central section, a tongue extending outwardly from a first portion of the central section for coupling to a corresponding longitudinal groove in an adjacent panel, and a wedge section extending outwardly from a second portion of the central section and between the extension flanges of the pair of panels,
wherein respective side surfaces of the wedge section directly contact the extension flanges to limit angular un-folding of the pair of panels to a maximum desired angle.

2. The system claim 1, wherein the wedge section comprises an outwardly flared pie-shape.

3. The system of claim 1, further comprising a hinge pin, wherein the central section has a central opening for accepting the hinge pin.

4. The system of claim 3, wherein the plurality of hinge knuckles comprise a first partial length hinge knuckle disposed at a bottom of the hinge pin, a second partial length hinge knuckle disposed at a top of the hinge pin, and a plurality of full length hinge knuckles disposed on the hinge pin between the first and second partial length hinge knuckles.

5. The system of claim 1, wherein the maximum desired angle is about 110°.

6. The system of claim 1, further comprising:
a track positioned across a space to be secured; and
mounting roller assemblies disposed on upper margins of selected panels for mounting the panels on the track.

7. The system of claim 1, further comprising upper and lower hinges mounted respectively at top and bottom margins of each panel for hinging adjacent panels together.

8. A folding door system, comprising:
a pair of panels arranged side-by-side; and
a hinge assembly disposed between a pair of panels, each of the pair of panels including a side edge having a longitudinal groove and an extension flange,
wherein the hinge assembly comprises:
a plurality of hinge knuckles disposed vertically end-to-end, at least one of the hinge knuckles comprising a central section, an outwardly extending tongue for coupling to a corresponding longitudinal groove in an adjacent panel, and a wedge section extending outwardly between the extension flanges of the pair of panels,
wherein the wedge section comprises a pair of opposing straight sides that flare outward to an outer edge of the wedge,
wherein respective straight sides of the wedge section directly contact the extension flanges to limit angular un-folding of the pair of panels to a maximum desired angle.

9. The system of claim 8, wherein at least one of the opposing straight sides of the wedge section extends from the central section to the outer edge of the wedge.

10. The system of claim 8, wherein the tongue extends outwardly from a first portion of the central section.

11. The system of claim 10, wherein the wedge extends outwardly from a second portion of the central section.

12. The system of claim 8, further comprising a hinge pin, wherein the central section has a central opening for accepting the hinge pin.

13. The system of claim 8, further comprising:
a track positioned across a space to be secured; and
mounting roller assemblies disposed on upper margins of selected panels for mounting the panels on the track.

14. The system of claim 8, further comprising upper and lower hinges mounted respectively at top and bottom margins of each panel for hinging adjacent panels together.

15. A folding door system, comprising:
a pair of panels arranged side-by-side; and
a hinge assembly disposed between a pair of panels, each of the pair of panels including a side edge having a longitudinal groove and an extension flange,
wherein the hinge assembly comprises:
a plurality of hinge knuckles disposed vertically end-to-end, at least one of the hinge knuckles comprising a central section, an outwardly extending tongue for coupling to a corresponding longitudinal groove in an adjacent panel, and a wedge section extending outwardly between the extension flanges of the pair of panels,
wherein respective side surfaces of the wedge section directly contact the extension flanges to limit angular un-folding of the pair of panels to a maximum desired angle, and
wherein the folding door system is configured to prevent the extension flanges from contacting the tongue.

16. The system of claim 15, wherein the folding door system is further configured to prevent the extension flanges from contacting the central section.

17. The system claim 15, wherein the wedge section comprises an outwardly flared pie-shape.

18. The system of claim 15, further comprising a hinge pin, wherein the central section has a central opening for accepting the hinge pin.

19. The system of claim 15, further comprising:
a track positioned across a space to be secured; and
mounting roller assemblies disposed on upper margins of selected panels for mounting the panels on the track.

20. The system of claim 15, further comprising upper and lower hinges mounted respectively at top and bottom margins of each panel for hinging adjacent panels together.
